(19) United States
(12) Patent Application Publication
(10) Pub. No.: US 2023/0386124 A1
(43) Pub. Date: Nov. 30, 2023

(54) THREE DIMENSIONAL IMAGE GENERATION METHOD AND SYSTEM FOR GENERATING AN IMAGE WITH POINT CLOUDS

(71) Applicant: QISDA CORPORATION, Taoyuan City (TW)

(72) Inventor: Tsung-Hsi Lee, Taoyuan City (TW)

(73) Assignee: QISDA CORPORATION, Taoyuan City (TW)

(21) Appl. No.: 18/201,177

(22) Filed: May 23, 2023

(30) Foreign Application Priority Data
May 27, 2022 (CN) 202210594341.0

(51) Int. Cl. G06T 15/08; G06T 7/521; G06T 7/00; G06T 7/55

(52) U.S. Cl. CPC G06T 15/08; G06T 7/521; G06T 7/0012; G06T 7/55; G06T 2207/10028; G06T 2207/30036; G06T 2207/30168

(57) ABSTRACT

A three dimensional image generation method can include projecting a plurality of first projected patterns to an object to generate a first image, capturing the first image, projecting a plurality of second projected patterns to the object to generate a second image, capturing the second image, decoding the first image to generate a first cloud point, decoding the second image to generate a second point cloud, and generating the three dimensional image of the object according to the first point cloud and the second point cloud. The first point cloud can be corresponding to a first resolution, the second point cloud can be corresponding to a second resolution, and the first resolution can be lower than the second resolution.

### BACKGROUND OF THE INVENTION

### 1. Field of the Invention

The disclosure is related to a three dimensional image generation method and system, and more particularly, a three dimensional image generation method and system for generating an image with point clouds.

### 2. Description of the Prior Art

With the development of technology, more and more professionals begin to use optical auxiliary devices to ease related operations and improve the accuracy of related operations. For example, in the field of dentistry, intraoral scanners can assist dentists in detecting the oral cavity. Intraoral scanners can capture intraoral images and convert the images into digital data to assist professionals such as dentists and denture technicians for diagnosis, treatment and denture fabrication.

When an intraoral scanner is in use to obtain images of teeth, due to the limited space in the oral cavity, the user must continuously move the intraoral scanner to obtain multiple images. The multiple images can be combined to generate a more complete three dimensional (3D) image.

In practice, it has been observed that the generated three dimensional images are often deformed, resulting in poor image quality. According to related analysis, the poor quality of the three dimensional images is often caused by the poor quality of the images corresponding to the structured projected patterns. Hence, interferences of noise, errors of identifying the boundaries in the image, and decoding errors are observed. Since the accuracy of each piece of three dimensional point cloud data is insufficient, errors are accumulated after combining multiple pieces of image data, decreasing the quality of the generated three dimensional image. A solution is still in need to improve the quality of the generated three dimensional image.

### SUMMARY OF THE INVENTION

An embodiment provides a three dimensional image generation method. The method can include projecting a plurality of first projected patterns to an object to generate a first image, capturing the first image, projecting a plurality of second projected patterns to the object to generate a second image, capturing the second image, decoding the first image to generate a first cloud point, decoding the second image to generate a second point cloud, and generating the three dimensional image of the object according to the first point cloud and the second point cloud. The first point cloud can be corresponding to a first resolution, the second point cloud can be corresponding to a second resolution, and the first resolution can be lower than the second resolution.

Another embodiment provides a three dimensional image generation system. The system can include a projector, a camera and a processor. The projector can be used to project a plurality of first projected patterns to an object to generate a first image, and project a plurality of second projected patterns to the object to generate a second image. The camera can be used to capture the first image and the second image. The processor can be used to decode the first image to generate a first cloud point, decode the second image to generate a second point cloud, and generate the three dimensional image of the object according to the first point cloud and the second point cloud. The first point cloud can be corresponding to a first resolution, the second point cloud can be corresponding to a second resolution, and the first resolution can be lower than the second resolution.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a three dimensional image generation system according to an embodiment.

FIG. 2 illustrates a flowchart of a three dimensional image generation method performed with the three dimensional image generation system in FIG. 1.

FIG. 3 illustrates that the first projected patterns and the second projected patterns are projected to the object according to an embodiment.

FIG. 4 illustrates gray code projected patterns according to an embodiment.

FIG. 5 illustrates line shift projected patterns according to an embodiment.

FIG. 6 to FIG. 8 illustrate flowcharts of generating the three dimensional image using the first point cloud and the second point cloud according to different embodiments.

### DETAILED DESCRIPTION

For improving the quality of the generated three dimensional (3D) image, embodiments can provide solutions as below.

In the text, three dimensional data of an object can be constructed using structured light patterns (e.g. the first projected patterns L1 and the second projected patterns L2 mentioned below).

In the text, a three dimensional volume can be volume data including 3D entities that have information inside them. A volumetric object can be represented as a large 3D grid of voxels, where a voxel can be the 3D counterpart of the two dimensional (2D) pixel.

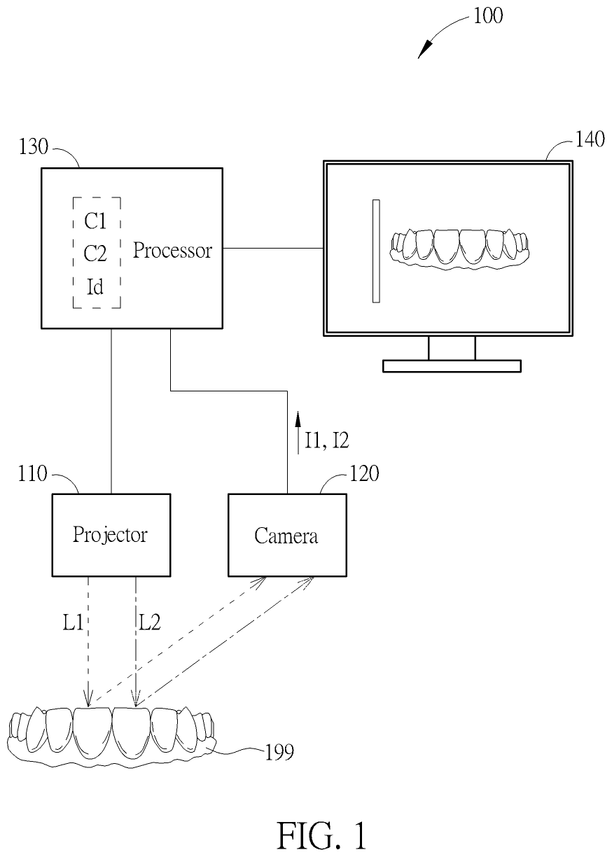

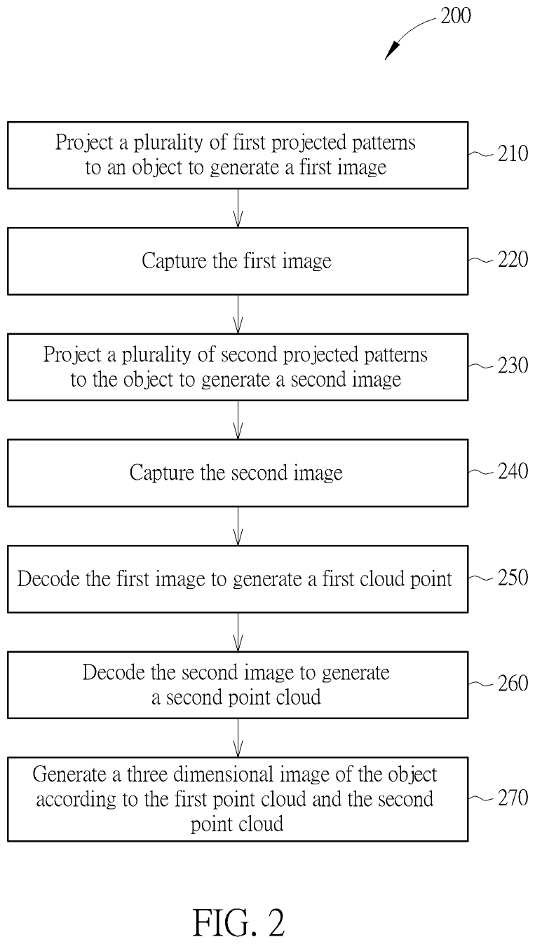

FIG. 1 illustrates a three dimensional image generation system 100 according to an embodiment. The three dimensional image generation system 100 can include a projector 110, a camera 120, a processor 130 and a display 140. FIG. 2 illustrates a flowchart of a three dimensional image generation method 200 performed with the three dimensional image generation system 100 in FIG. 1. The three dimensional image generation method 200 can include the following steps.

Step 210: project a plurality of first projected patterns L1 to an object 199 to generate a first image I1;

Step 220: capture the first image I1;

Step 230: project a plurality of second projected patterns L2 to the object 199 to generate a second image 12;

Step 240: capture the second image 12;

Step 250: decode the first image I1 to generate a first cloud point C1;

Step 260: decode the second image 12 to generate a second point cloud C2; and

Step 270: generate a three dimensional image Id of the object 199 according to the first point cloud C1 and the second point cloud C2.

After Step 240 is performed, the images can be analyzed to check whether the quality of the first image I1 and second image 12 reach a threshold. If the quality of the first image I1 and the second image 12 fails to reach the threshold, the first image I1 and the second image 12 can be abandoned and not used. The quality of the first image I1 and second image 12 can be checked in a two dimensional format. For example, if the images are too blurry to detect textures and boundaries, or if the movement corresponding to two images is excessively large, the images can be abandoned and not processed.

The first point cloud C1 can be corresponding to a first resolution. The second point cloud C2 can be corresponding to a second resolution higher than the first resolution. The projector 110 can be used to perform Steps 210 and 230. The camera 120 can be used to perform Steps 220 and 240. The processor 130 can be used to perform Steps 250, 260 and 270. The display 140 can be used to display the three dimensional image Id generated in Step 270.

In FIG. 1, the object 199 can include teeth as an example to describe the application of the three dimensional image generation system 100. However, embodiments are not limited thereto.

The projector 110 can include a digital micromirror device. By controlling a plurality of small-sized micromirrors to reflect light, the predetermined first projected patterns L1 and second projected patterns L2 can be generated. The camera 120 can include a charge-coupled device (CCD). The camera 120 can be the only camera used for capturing the first image I1 and the second image 12 in the three dimensional image generation system 100.

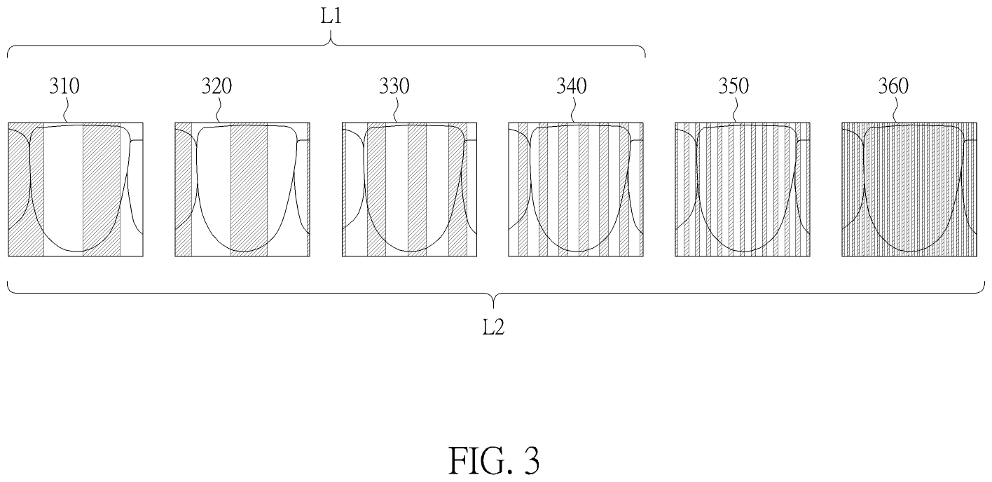

In FIG. 1 and FIG. 2, the first projected patterns L1 can be identical to a part of the second projected patterns L2. FIG. 3 illustrates that the first projected patterns L1 and the second projected patterns L2 are projected to the object 199 according to an embodiment. FIG. 3 is merely an example, and embodiments are not limited thereto. In FIG. 3, the first projected patterns L1 can include projected patterns 310, 320, 330 and 340. The second projected patterns L2 can include projected patterns 310, 320, 330, 340, 350 and 360. The projected patterns 310 to 360 can include stripe patterns. From the projected pattern 310 to the projected pattern 360, the widths of the stripes and the intervals can be gradually decreased.

The number of the first projected patterns L1 can be smaller than the number of the second projected patterns L2. In FIG. 3, the first projected patterns L1 can include 4 patterns, so 2⁴ gray codes (i.e. 16 gray codes) can be generated. The second projected patterns L2 can include 6 patterns, so 2⁶ gray codes (i.e. 64 gray codes) can be generated. Hence, the first projected pattern L1 can be corresponding to a lower resolution, and the second projected pattern L2 can be corresponding to a higher resolution.

A rough image of the object 199 can be generated according to the first point cloud C1, and details of the rough image can be adjusted according to the second point cloud C2 to generate the three dimensional image Id of the object 199. The first point cloud C1 generated according to the first projected patterns L1 can be a rougher point cloud with a lower resolution and less noises, so the first point cloud C1 can be used to form the three dimensional outline of the object 199 to avoid the drop of accuracy caused by noises. The second point cloud C2 generated according to the second projected patterns L2 can be a finer point cloud with a higher resolution and more noises, so the second point cloud C2 can be used to fill in the three dimensional details of the object 199. By using the first point cloud C1 and the second point cloud C2 to generate the three dimensional image Id, the accuracy and details of the three dimensional image Id are both improved.

In FIG. 1 and FIG. 2, the first projected patterns L1 and the second projected patterns L2 are of the same type (e.g. gray code projected patterns, or line shift projected patterns). When the number of the first projected patterns L1 is smaller than the number of the second projected patterns L2, the first projected patterns L1 can be a subset of the second projected patterns L2.

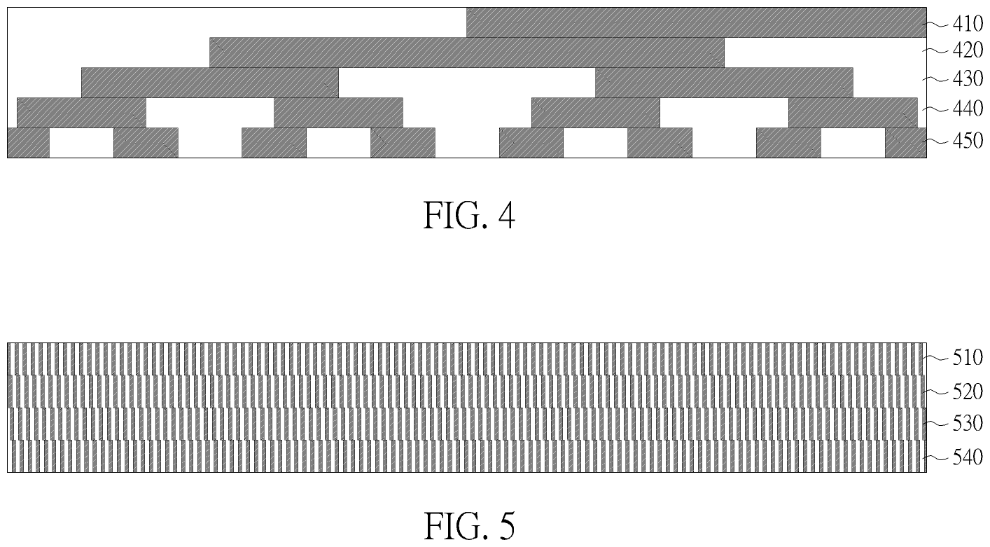

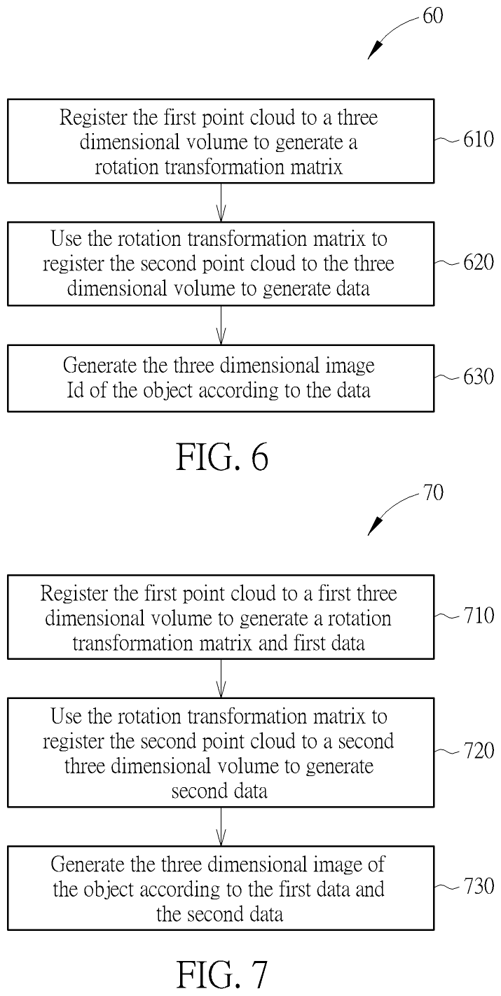

In another embodiment, the first projected patterns L1 can be of a first type, and the second projected patterns L2 can be of a second type different from the first type. For example, the first projected patterns L1 can be gray code projected patterns, and the second projected patterns L2 can be line shift projected patterns. In another example, the first projected patterns L1 can be line shift projected patterns, and the second projected patterns L2 can be gray code projected patterns. FIG. 4 illustrates gray code projected patterns according to an embodiment. FIG. 5 illustrates line shift projected patterns according to an embodiment. In FIG. 4, 5 projected patterns (i.e. projected patterns 410 to 450) can be used to generate 2⁵ gray codes, i.e. 32 gray codes. In FIG. 5, the lines can be shifted three times to generate 4 projected patterns 510 to 540. FIG. 4 and FIG. 5 are merely examples, and embodiments are not limited thereto.

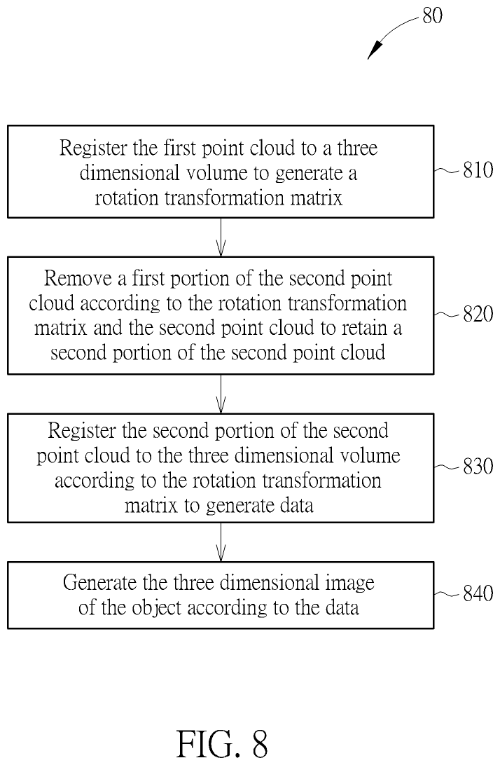

FIG. 6 illustrates a flowchart of generating the three dimensional image Id using the first point cloud C1 and the second point cloud C2 according to an embodiment. FIG. 6 can be corresponding to Step 270 in FIG. 2. As shown in FIG. 6, Step 270 can include the following steps.

Step 610: register the first point cloud C1 to a three dimensional volume to generate a rotation transformation matrix;

Step 620: use the rotation transformation matrix to register the second point cloud C2 to the three dimensional volume to generate data; and

Step 630: generate the three dimensional image Id of the object 199 according to the data.

In Steps 610 and 620, the first point cloud C1 and the second point cloud C2 can be registered to the same three dimensional volume. The data mentioned in Steps 620 and 630 can include voxels in the three dimensional volume. After performing registration and generating the rotation transformation matrix in Step 610, at least a portion of the first point cloud C1 can be selectively removed, and/or data corresponding to at least a portion of the first point cloud C1 in the three dimensional volume can be selectively removed. The three dimensional volume in Step 610 and the three dimensional volume in Step 620 can be the same space.

In FIG. 2 and FIG. 6, Steps 210 to 270 and Steps 610 to 630 can be performed repeatedly to collect data generated by scanning a plurality of portions of the object 199. After the scanning is stopped, post processing can be performed to perform three dimensional combination to generate a three dimensional model of the object 199.

FIG. 7 illustrates a flowchart of generating the three dimensional image Id using the first point cloud C1 and the second point cloud C2 according to another embodiment. FIG. 7 can be corresponding to Step 270 in FIG. 2. As shown in FIG. 7, Step 270 can include the following steps.

Step 710: register the first point cloud C1 to a first three dimensional volume to generate a rotation transformation matrix and first data;

Step 720: use the rotation transformation matrix to register the second point cloud C2 to a second three dimensional volume to generate second data; and

Step 730: generate the three dimensional image Id of the object 199 according to the first data and the second data.

Compared with FIG. 6, in FIG. 7, the first point cloud C1 and the second point cloud C2 are registered to two different three dimensional volumes. In Step 720, the rotation transformation matrix generated in Step 710 can be used to perform registration. The first data and the second data mentioned in Steps 710 and 720 can include voxels.

In FIG. 2 and FIG. 7, Steps 210 to 270 and Steps 710 to 730 can be performed repeatedly to collect data generated by scanning a plurality of portions of the object 199. After the scanning is stopped, post processing can be performed to combine different portions to generate a three dimensional model of the object 199.

FIG. 8 illustrates a flowchart of generating the three dimensional image Id using the first point cloud C1 and the second point cloud C2 according to another embodiment. FIG. 8 can be corresponding to Step 270 in FIG. 2. As shown in FIG. 8, Step 270 can include the following steps.

Step 810: register the first point cloud C1 to a three dimensional volume to generate a rotation transformation matrix;

Step 820: remove a first portion of the second point cloud C2 according to the rotation transformation matrix and the second point cloud C2 to retain a second portion of the second point cloud C2;

Step 830: register the second portion of the second point cloud C2 to the three dimensional volume according to the rotation transformation matrix to generate data; and

Step 840: generate the three dimensional image Id of the object 199 according to the data.

In Step 810, the rotation transformation matrix generated by performing registration can be stored for later use. In Step 820, for example, data points of repetitive positions and/or lower quality (such as abnormal outliers, bumps, damage and so on in the image) can be removed to leave the second portion of the second point cloud C2 with higher quality. As a result, the three dimensional image Id with fewer combination errors and better quality in details is generated accordingly. The three dimensional volume in Step 810 and the three dimensional volume in Step 820 can be the same space.

After performing registration and generating the rotation transformation matrix in Step 810, at least a portion of the first point cloud C1 can be selectively removed, and/or data corresponding to at least a portion of the first point cloud C1 can be selectively removed in the three dimensional volume. In FIG. 2 and FIG. 8, Steps 210 to 270 and Steps 810 to 840 can be performed repeatedly to collect data generated by scanning a plurality of portions of the object 199. After the scanning is stopped, post processing can be performed to combine different portions to generate a three dimensional model of the object 199.

In summary, through the three dimensional image generation system 100 and the three dimensional image generation method 200, rougher point cloud(s) can be used to form the three dimensional outline of the object 199 to avoid the drop of accuracy caused by noises. Finer point cloud(s) with higher resolution(s) can be used to adjust details of the three dimensional image Id of the object 199. As a result, in the generated three dimensional image Id, the accuracy of shape and the quality of details are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three dimensional image generation method, comprising:
projecting a plurality of first projected patterns to an object to generate a first image;
capturing the first image;
projecting a plurality of second projected patterns to the object to generate a second image;
capturing the second image;
decoding the first image to generate a first cloud point;
decoding the second image to generate a second point cloud; and
generating a three dimensional image of the object according to the first point cloud and the second point cloud;
wherein the first point cloud is corresponding to a first resolution, the second point cloud is corresponding to a second resolution, and the first resolution is lower than the second resolution.

2. The method of claim 1, wherein the plurality of first projected patterns are identical to a part of the plurality of second projected patterns.

3. The method of claim 1, wherein the plurality first projected patterns and the plurality of second projected patterns are of a same type, and the plurality of first projected patterns are different from a part of the plurality of second patterns.

4. The method of claim 1, wherein the plurality of first projected patterns are of a first type, and the plurality of second projected patterns are of a second type different from the first type.

5. The method of claim 1, wherein:
the plurality of first projected patterns are gray code projected patterns, and the plurality of second projected patterns are line shift projected patterns.

6. The method of claim 1, wherein:
the plurality of first projected patterns are line shift projected patterns, and the plurality of second projected patterns are gray code projected patterns.

7. The method of claim 1, wherein a number of the plurality of first projected patterns is smaller than a number of the plurality of second projected patterns.

8. The method of claim 1, wherein generating the three dimensional image of the object according to the first point cloud and the second point cloud, comprises:
registering the first point cloud to a three dimensional volume to generate a rotation transformation matrix;
using the rotation transformation matrix to register the second point cloud to the three dimensional volume to generate data; and
generating the three dimensional image of the object according to the data.

9. The method of claim 8, further comprising:
removing at least a portion of the first point cloud; and/or
removing data corresponding to at least a portion of the first point cloud in the three dimensional volume.

10. The method of claim 1, wherein generating the three dimensional image of the object according to the first point cloud and the second point cloud, comprises:
registering the first point cloud to a first three dimensional volume to generate a rotation transformation matrix and first data;
using the rotation transformation matrix to register the second point cloud to a second three dimensional volume to generate second data; and
generating the three dimensional image of the object according to the first data and the second data.

11. The method of claim 1, wherein generating the three dimensional image of the object according to the first point cloud and the second point cloud, comprises:
registering the first point cloud to a three dimensional volume to generate a rotation transformation matrix;
removing a first portion of the second point cloud according to the rotation transformation matrix and the second point cloud to remain a second portion of the second point cloud;
registering the second portion of the second point cloud to the three dimensional volume according to the rotation transformation matrix to generate data; and
generating the three dimensional image of the object according to the data.

12. The method of claim 11, further comprising:
removing at least a portion of the first point cloud; and/or
removing data corresponding to at least a portion of the first point cloud in the three dimensional volume.

13. The method of claim 1, further comprising:
checking whether quality of the first image and second image reach a threshold; and
abandoning the first image and the second image if the quality fails to reach the threshold.

14. The method of claim 13, wherein the quality of the first image and second image is checked in a two dimensional format.

15. The method of claim 1, wherein generating the three dimensional image of the object according to the first point cloud and the second point cloud, comprises:
generating a rough image of the object according to the first point cloud; and
adjusting details of the rough image according to the second point cloud to generate the three dimensional image of the object.

16. A three dimensional image generation system, comprising:
a projector configured to project a plurality of first projected patterns to an object to generate a first image, and project a plurality of second projected patterns to the object to generate a second image;
a camera configured to capture the first image and the second image; and
a processor configured to decode the first image to generate a first cloud point, decode the second image to generate a second point cloud, and generate a three dimensional image of the object according to the first point cloud and the second point cloud;
wherein the first point cloud is corresponding to a first resolution, the second point cloud is corresponding to a second resolution, and the first resolution is lower than the second resolution.

17. The system of claim 16, wherein the projector comprises a digital micromirror device.

18. The system of claim 16, wherein the camera is the only camera used for capturing the first image and the second image.
